(19) United States
(12) Patent Application Publication
(10) Pub. No.: US 2024/0226708 A1
(43) Pub. Date: Jul. 11, 2024

(54) Adapter for a Court-Illumination System

(71) Applicants: Michael Cordova, Lake Mary, FL (US); Jason R. Cordova, Lake Mary, FL (US)

(72) Inventors: Michael Cordova, Lake Mary, FL (US); Jason R. Cordova, Lake Mary, FL (US)

(21) Appl. No.: 18/612,796

(22) Filed: Mar. 21, 2024

Related U.S. Application Data
(63) Continuation-in-part of application No. 18/318,517, filed on May 16, 2023.
(60) Provisional application No. 63/345,257, filed on May 24, 2022.

(51) Int. Cl. A63C 19/00; F16B 5/00; F21V 21/00; F21W 131/105

(52) U.S. Cl. CPC A63C 19/00; F16B 5/0024; A63C 2203/14; F21V 21/00; F21W 2131/105

(57) ABSTRACT

An adapter is provided. The adapter features a main body with a flat panel and a series of uniquely designed brackets for enhanced connectivity. Each bracket comprises a central plate with a connector portion, flanked by two outer plates, separated by gaps from the connector. This structure offers robust support and versatile connection capabilities, suitable for diverse applications. The adapter's innovative bracket design ensures reliable functionality and structural integrity.

### FIELD OF THE INVENTION

The present invention generally relates to the field of sports facility enhancements, more specifically to an apparatus and method for the installation of lighting systems within sports environments. Specifically, the invention pertains to an adapter designed to facilitate the quick and efficient installation of ultraviolet (UV) illumination systems for enhancing the visibility and aesthetic appeal of playing courts under low-light conditions.

### BACKGROUND OF THE INVENTION

An adapter designed to facilitate the quick and efficient installation of ultraviolet (UV) illumination systems is in demand.

Sports are a universal source of enjoyment, bringing together millions of people from all corners of the globe. They offer not only entertainment but also opportunities for physical health, teamwork, and personal achievement. However, the traditional experience of playing and engaging in sports has seen limited innovation over the years. This lack of variation can lead to a sense of monotony, potentially causing players to lose interest over time. Additionally, the constraints imposed by lighting conditions significantly limit when and where sports can be played, particularly affecting those who are available only during evening or night hours.

The use of indoor and outdoor lit courts attempts to address these limitations, yet each comes with its own set of challenges. Indoor courts, while sheltered from the elements, suffer from space constraints that can lead to overcrowding and a less enjoyable playing experience. Outdoor lit courts, on the other hand, offer more space but may still fail to provide adequate visibility for all players, impacting the quality of play and potentially the safety of the participants.

Given these challenges, there is a clear and present need for an innovative solution that not only enhances the playing court environment but also simplifies the process of installing such enhancements. The goal is to invigorate the player experience with novel and exciting gameplay options while overcoming the traditional barriers posed by court lighting and installation complexities.

The present invention introduces an adapter designed to streamline the installation of an ultraviolet (UV) court-illumination system. This system aims to revolutionize the sports playing experience by using UV court lights to illuminate playing courts in a vibrant and visually engaging manner. The adapter is a pivotal component of this system, offering a user-friendly solution that facilitates quick and easy setup, thereby making advanced lighting systems accessible to a broader range of sports facilities and private users alike.

By incorporating fluorescent game boundary-markers and game fixtures that are specifically designed to fluoresce under UV light, the system not only enhances visibility but also adds an element of visual excitement to the game. Whether it's a net, hoop, goal, or any other essential sports equipment, the use of fluorescence under UV lighting creates a dynamic playing environment that can rekindle interest in the sport and extend playable hours into the night. Thus, there is a need to enhance the sports playing experience through innovative lighting while also simplifying the installation process.

The present invention is intended to address problems associated with and/or otherwise improve on conventional devices through an innovative adapter that is designed to provide convenient, effective, and inexpensive installation while offering high levels of performance and incorporating other problem-solving features.

### SUMMARY

In accordance with the present invention, a novel equipment mounting interface adapter is provided. The present invention offers a novel solution for integrating lighting and power connectivity in various applications. The adapter comprises a main panel, characterized by a flat panel design with a plurality of holes for attachment to additional equipment.

In one embodiment, the dimensions of the main panel are meticulously designed, with two opposing sides measuring 4⅛ inches and the other two sides measuring 4 7/16 inches, and a thickness ranging from 1/16 inches to ⅛ inches.

Attached to the main panel are a plurality of brackets, which are mechanical components made from durable materials such as aluminum or steel. These brackets are designed to be substantially rectangular with rounded corners, contributing to the adapter's lightweight characteristics and structural integrity.

The brackets feature a plurality of holes for secure mounting and may include a tab or extension for additional leverage, alignment capabilities, or connectivity with other components.

The adapter is constructed from high-quality, durable materials capable of withstanding environmental factors and operational wear and tear. This ensures the adapter's longevity and reliability in various applications, including supporting telescopic poles and fence hanging brackets. The design allows for versatile use, making it particularly suited for outdoor or industrial environments where reliable power connectivity is essential.

The present invention provides a stable and reliable power connection solution, facilitating the direct attachment of power to equipment necessary for a wide range of applications.

### BRIEF DESCRIPTION OF THE DRAWINGS

FIG. 1 is an illustration of one embodiment of the present invention.

FIG. 2 is a top view of one embodiment of the bracket of the present invention.

FIG. 3 is a front view of one embodiment of the bracket of the present invention.

FIG. 4 is a perspective view of one embodiment of the bracket of the present invention.

FIG. 5 is a perspective view of an alternative embodiment of the bracket of the present invention with a sing tab on one side.

FIG. 6 is an illustration of one embodiment of the bracket attached on a hollow column.

### DETAIL DESCRIPTIONS OF THE INVENTION

All illustrations of the drawings are for the purpose of describing selected versions of the present invention and are not intended to limit the scope of the present invention.

The present invention (equipment mounting interface adapter) introduces an innovative equipment mounting interface adapter that serves as a critical intermediary between a black light, a power source, and a power receptacle junction box. The present invention can be crafted for permanent installation onto the back of an outer enclosure, ensuring a secure and durable mounting solution.

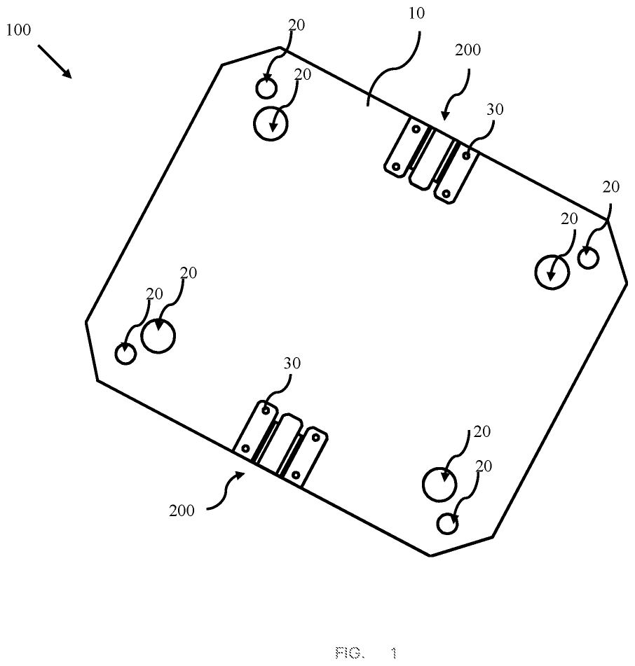

The present invention, as shown in FIG. 1, provides an adapter (equipment mounting interface adapter) comprising: a main body 10, and a plurality of brackets 200 attached to the main body 10.

The main body 10 can be a flat panel with a plurality of holes 20 arranged to facilitate the attachment of the panel to additional equipment. The flat panel can be made of wood or other suitable material.

In a specific embodiment of the invention, the flat panel can be designed with two opposing sides each measuring 4⅛ inches in length, and the remaining two opposing sides are each 4 7/16 inches in length. The thickness of the flat panel may range from 1/16 inches to ⅛ inches.

In certain embodiments, the four corners of the flat panel may also be rounded or precisely trimmed to eliminate sharp edges.

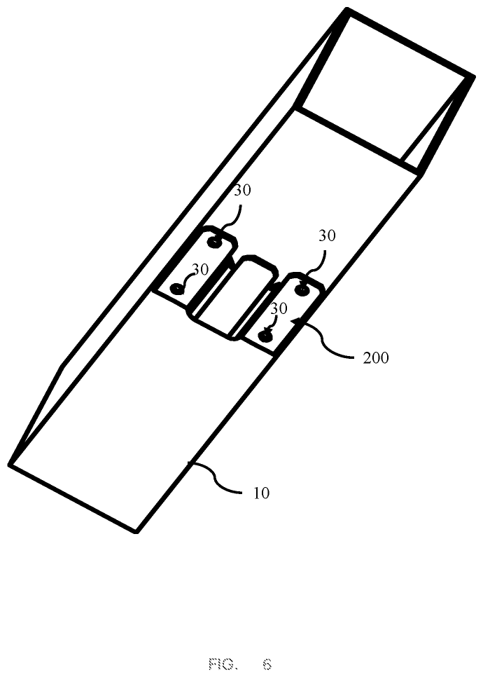

In one embodiment, the main body 10 can be a hollow column in the shape of a square column, as shown in FIG. 6.

The hollow column (main body 10) may serve as a component of a lighting fixture, can be designed to attach to a pole in a sliding manner, allowing for its height to be adjusted. This feature may be integral to the process of adjustment or assembly, and the hollow column can be affixed to an adjustable riser for further customization in setting an ultraviolet (UV) court-illumination system. The hollow column may be made from wood, steel or any other suitable material.

The plurality of brackets 200 can be attached to the main body 10 and the brackets 200 may include any suitable shape. The plurality of brackets 200 can be attached to near the opposing sides of the flat panel. The plurality of brackets 200 can also be attached to one or more surfaces of the hollow column.

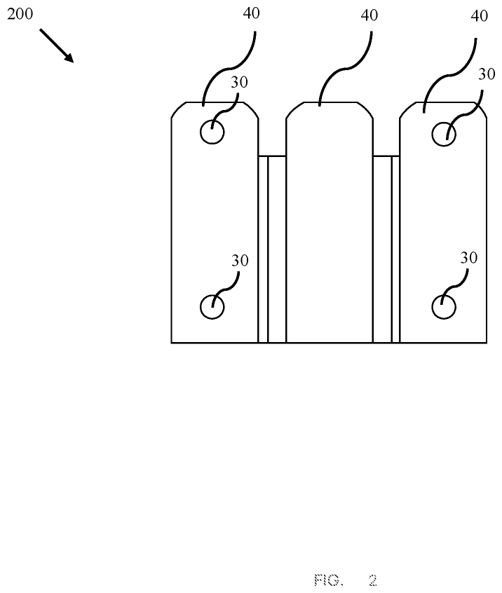

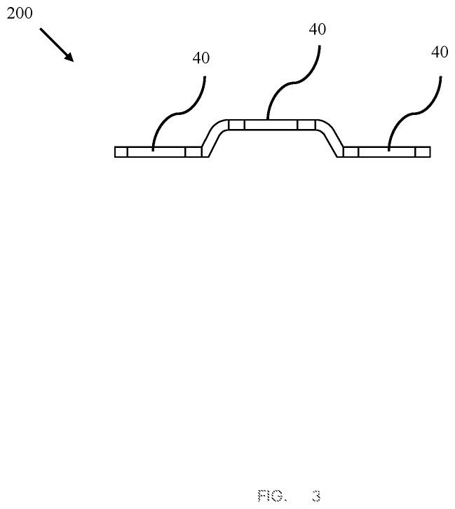

The bracket, as shown in FIGS. 2-4, is a mechanical component fabricated from a durable material, such as aluminum or steel, ensuring both lightweight characteristics and structural integrity.

The bracket 200 can be substantially rectangular with rounded corners to minimize wear and tear and reduce damage to court surface to prevent injury during manual handling.

The bracket 200 is versatile in application, suitable for use in various mechanical systems where secure mounting, precise alignment, quick conversion and robust connectivity are required.

In some embodiments, the bracket 200 may include a plurality of holes 30 which can be located near the four corners of the rectangular bracket to facilitate secure mounting or attachment to the main body 10.

In preferred embodiment, the bracket 200 includes one or more tabs 40 or extension at one side or opposing sides.

In one embodiment, the bracket 200 can include three tabs 40 aligned on one lateral side, wherein the central tab 40 among these is configured to be recessed in relation to the plane of the adjacent tabs 40. This configuration is intended to enhance the mechanical functionality and/or assembly characteristics of the bracket.

In a further embodiment, the bracket 200 may additionally incorporate a singular tab 41 positioned on the side opposite to that bearing the aforementioned trio of tabs 40.

This particular arrangement may improve the ease with which the bracket 200 can be manipulated and held during installation.

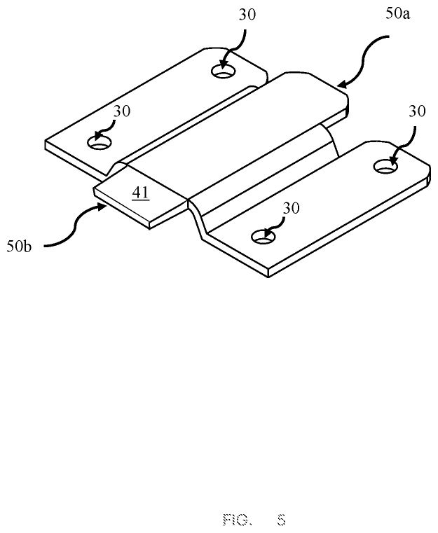

In such embodiments, as shown in FIG. 5, the adapter 100 may include a plurality of brackets 200 that include a first side 50a and an opposing second side 50b; three tabs 40 integrally formed with and protruding from the first side 50a; and a single tab 41 integrally formed with and extending from the opposing second side 50b, wherein the second side 50b is opposite the first side 50a, thereby facilitating multi-directional engagement with corresponding structures.

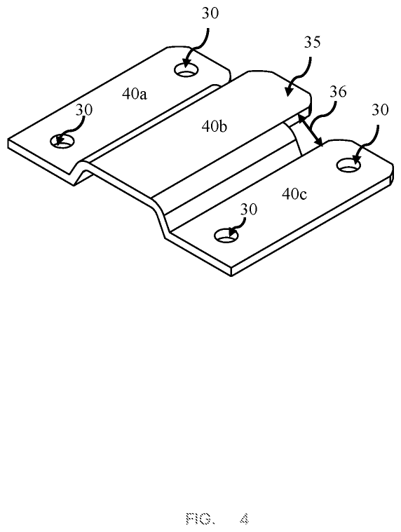

FIG. 4. presents a top perspective view of the bracket.

In one embodiment, the bracket 200 may include two outer plates 40a, 40c and one central plate 40b, each with a rectangular shape, with a pair of rounded top corners providing a non-acute interface to connected parts. The central plate 40b can be the tab or extension described in above embodiments.

Each outer plate 40a, 40c may contain a circular through-hole 30 located near the top and bottom end for accommodating fastening means such as bolts, rivets, or screws.

The central plate 40b can be placed between the two outer plates 40a, 40c, with its surface being slightly recessed in relation to the surfaces of the outer plates 40a, 40c. This recess serves to provide ample clearance for the accommodation of adjoining parts.

In one embodiment, the central plate 40b is endowed with a connector portion 35 located at one terminus. This connector portion 35 is not affixed to the adjacent outer plate 40a, 40c, resulting in the formation of an unattached margin. Such a configuration establishes a gap 36 between the outer plate 40a, 40c and the central plate 40b, a feature designed to facilitate specific functional or assembly requirements. In such embodiments, the bracket 200 may include a gap 36 between the outer plate 40a, 40c and the central plate 40b.

The outer plates 40a, 40c and the central plate 40b can be aligned parallel to each other and may feature an interlocking mechanism or may be welded or adhesively bonded to maintain the configuration.

In some embodiments, the outer plates 40a, 40c and the central plate 40b are of a uniform thickness to ensure consistent strength across the connection points.

The material composition of the bracket 200 can be of various types depending on the specific application, including but not limited to steel, aluminum, composite materials, or plastic.

In some embodiments, the adapter components including the main body 10 and the bracket 200 can be constructed from high-quality, durable materials capable of withstanding environmental factors and operational wear and tear, ensuring longevity and reliability.

This adapter 100 facilitates the direct attachment of power to equipment necessary for various applications. It is engineered to support a wide range of equipment, including telescopic poles and fence hanging brackets, by providing a stable and reliable power connection.

The adapter's design allows for versatile use across different settings and equipment types. It is particularly suited for outdoor or industrial environments where reliable power connectivity is essential.

The equipment mounting interface adapter finds applications in various fields requiring the integration of lighting and power connectivity solutions. It is especially useful in settings where telescopic poles and fence hanging brackets are employed, providing a seamless and efficient power connection solution.

Although the invention has been explained in relation to its preferred embodiment, it is to be understood that many other possible modifications and variations can be made without departing from the spirit and scope of the invention.

What is claimed is:

1. An adapter comprising:
a main body, wherein the main body includes a flat panel; and
a plurality of brackets having one or more tabs, the plurality of brackets are attached to the flat panel.

2. The adapter as claimed in claim 1, wherein the plurality of brackets include a first side and an opposing second side; three tabs integrally formed with and protruding from the first side; and a single tab integrally formed with and extending from the opposing second side, wherein the second side is opposite the first side.

3. The adapter as claimed in claim 2, wherein the flat panel includes two opposing sides with 4⅛ inches in length, and two opposing sides with 4 7/16 inches in length.

4. The adapter as claimed in claim 3, wherein the flat panel includes a thickness range from 1/16 inches to ⅛ inches.

5. The adapter as claimed in claim 4, wherein the plurality of brackets include one or more holes.

6. The adapter as claimed in claim 1, wherein the plurality of brackets are made from aluminum material.

7. The adapter as claimed in claim 1, wherein the flat panel is made of wood.

8. The adapter as claimed in claim 1, wherein the flat panel is made of steel.

9. An adapter comprising:
a main body, wherein the main body includes a hollow column;
and a plurality of brackets having one or more tabs, the plurality of brackets are attached to the hollow column.

10. The adapter as claimed in claim 8, wherein the hollow column is a square column.

11. The adapter as claimed in claim 9, wherein the plurality of brackets include a first side and an opposing second side; three tabs integrally formed with and protruding from the first side; and a single tab integrally formed with and extending from the opposing second side, wherein the second side is opposite the first side.

12. The adapter as claimed in claim 10, wherein the plurality of brackets are made from aluminum material.

13. The adapter as claimed in claim 9, wherein the hollow column is made of wood.

14. The adapter as claimed in claim 8, wherein the hollow column is made of steel.

15. An adapter comprising:
a main body, wherein the main body includes a flat panel; and
a plurality of brackets, the plurality of brackets are attached to the flat panel, wherein the bracket includes a central plate, and two outer plates attached to the central plate, wherein the central plate includes a connector portion with two gaps between the connector portion and the outer plates.

16. The adapter as claimed in claim 15, wherein the flat panel include two opposing sides with 4⅛ inches in length, and two opposing sides with 4 7/16 inches in length.

17. The adapter as claimed in claim 16, wherein the flat panel includes a thickness range from 1/16 inches to ⅛ inches.

18. The adapter as claimed in claim 15, wherein the two outer plates include one or more holes.

19. The adapter as claimed in claim 18, wherein the plurality of brackets are made from aluminum material.

20. The adapter as claimed in claim 15, wherein the flat panel is made of wood.
